(19) United States
(12) Patent Application Publication
(10) Pub. No.: US 2026/0055546 A1
(43) Pub. Date: Feb. 26, 2026

(54) METHOD AND APPARATUS FOR DETERMINING A QUANTITY OF A LIQUID IN AN OSCILLATINGLY SUSPENDED CONTAINER

(71) Applicant: BSH Hausgeräte GmbH, München (DE)

(72) Inventors: Gudrun SCHLIECKER, Berlin (DE); Philipp SCHRADER, Berlin (DE)

(21) Appl. No.: 19/306,034

(22) Filed: Aug. 21, 2025

(30) Foreign Application Priority Data
Aug. 21, 2024 (DE) 10 2024 207 938.3

(51) Int. Cl. D06F 39/08; D06F 23/02; D06F 33/34; D06F 33/42; D06F 34/18; D06F 34/20; D06F 37/26; D06F 37/30; D06F 103/04; D06F 103/06; D06F 103/18; D06F 103/24; D06F 103/30; D06F 103/38; D06F 103/46; D06F 105/02; D06F 105/08; G01F 22/00

(52) U.S. Cl. CPC D06F 39/087; D06F 23/02; D06F 33/34; D06F 33/42; D06F 34/18; D06F 34/20; D06F 37/268; D06F 37/304; D06F 39/083; D06F 39/088; G01F 22/00; D06F 2103/04; D06F 2103/06; D06F 2103/18; D06F 2103/24; D06F 2103/30; D06F 2103/38; D06F 2103/46; D06F 2105/02; D06F 2105/08

(57) ABSTRACT

An apparatus carries out a method for determining a first quantity of a liquid in an oscillatingly suspended container. The liquid is supplied into the container with a supply valve and is discharged from the container with a discharging facility. Sensors are provided for continuously acquiring operating data of the container. A control facility is connected to the sensors for transmitting the operating data and controls a supply valve. The operating data is supplied to a correlation unit which on the basis of training data which is stored as learned correlations between the first quantity and the operating data, the correlation unit determines the first quantity from the operating data by the operating data being used as input variables for the correlation unit and the first quantity being an output variable of the correlation unit.

### CROSS-REFERENCE TO RELATED APPLICATION

This application claims the priority, under 35 U.S.C. § 119, of German Patent Application DE 10 2024 207 938.3, filed Aug. 21, 2024; the prior application is herewith incorporated by reference in its entirety.

### FIELD AND BACKGROUND OF THE INVENTION

The invention relates to a method for determining a quantity of a liquid in an oscillatingly suspended container. Sensors continuously acquire operating data of the container and supply it to a control facility connected to the sensors for controlling a supply of the liquid corresponding to the operating data and wherein the control facility determines the quantity from the operating data. The invention also relates to an apparatus for carrying out such a method.

European patent application EP 3 988 697 A1 discloses a method of the type defined above, the method implements in a laundry treatment machine, wherein the oscillatingly suspended container is an outer tub with a drum, which can rotate therein, for receiving items of laundry which are to be cared for. According to this document, foam, which can form when the drum and the items of laundry in liquid move, in particular suds or soapy water, with which the container is partially filled, is determined from a multitude of operating data of the container, especially since the foam can hardly be measured directly during a laundry care process, which foam is determined in the container by rotations of the drum and movements of the items of laundry in the drum and in the liquid. A “virtual sensor” is set up in the control facility assigned to the container, which sensor continuously ascertains a quantity of foam present in the container from the supplied operating data. The virtual sensor can be a trained data processing system, for example a trained neural network, in which training took place with measurement data ascertained by way of experiments on a model of the container with the drum.

U.S. patent disclosure 2020/0248357 A1 discloses a method in which an imbalance is determined in an oscillatingly suspended container of a laundry treatment machine set up with an appropriately trained neural network, which unbalance is caused by laundry which is moved in the container by a rotating drum. Not only is an imbalance which currently exists in each case determined in the process but a prognosis of the imbalance that occurs during the spinning process is made at the beginning of a spinning process, in which the laundry is centrifuged at a relatively high rotational speed of the drum in order to squeeze out suds or soapy water.

The treatment of items of laundry in a laundry care machine frequently includes a supply of water to the items of laundry to be cared for, which is also mixed with detergents containing, in particular, different surfactants, soaps, enzymes and water softeners to form suds or soapy water. To determine a quantity of water supplied to a corresponding container, in particular its volume or its mass, a flow sensor can be used through which water supplying the container has to flow. Similarly, the opening time of a valve, through which the supply from a water supply network takes place, and the pressure which the water is subject to in a pipe in which it flows to the container, can be determined in order to determine the quantity of the water which has flowed to the container. Furthermore, the container can also be provided with a pressure sensor which measures a hydrostatic pressure in the liquid present in the container. All of these methods for determining a quantity of the liquid present in the container are laborious and expensive, like the application of a flow sensor, or inaccurate, like the application of a pressure sensor and the measurement of the opening time of the valve.

A variance in the determination of a quantity of a liquid in a container entails the following variances in the application of such a liquid, for example if this liquid in a care procedure for the items of laundry, which are likewise situated in the container and are to be cared for, in particular washed, by means of the liquid. An excess of liquid can result in underdosing of an added cleaning product, in particular detergent, and in inadequate heating of the liquid during a heating process, an undersize of liquid can result in overdosing of the added cleaning product or in excessive heating of the liquid. If reciprocal movement of the items in the liquid is to take place, as is necessary in a customary washing or rinsing procedure for items of laundry, an undersize or excess of liquid can similarly result in undesirably high or low reciprocal movement. A procedure, intended for an automatic sequence, for the application of such a liquid in a container therefore has to take into account the variance in the determination of the quantity of the liquid in order to control and prevent drawbacks that result from the subsequent variances. In order to compensate for such drawbacks, the procedure potentially has to be lengthened, the specification of a quantity for the required liquid has to be increased, the specification for a temperature of the liquid has to be reduced or the addition of cleaning products has to be changed, possibly also by combining a plurality of such measures. Ultimately such actions compromise the procedure by increasing the effort associated with them and reducing their benefit.

### SUMMARY OF THE INVENTION

There is therefore a need for a method of the type defined in the introduction, together with an apparatus for its implementation, which method, with minimal expenditure on material and data processing, allows optimally accurate determination of a quantity of a liquid in an oscillatingly suspended container. It should also be possible to integrate the method in a procedure for the application of the liquid in order to optimize the procedure, in particular with regard to duration, requirement for liquid as well as adding additional agents to it, and expenditure of energy.

To achieve this object, a method with the generic features stated in the introduction and in the preamble to the corresponding independent claim, which also has the features of the characterizing part of the corresponding independent claim, and an apparatus for carrying out such a method as claimed in the corresponding independent claim are inventively disclosed.

Preferred embodiments of the invention are stated in the dependent claims as well as in the description below and these can also be applied in combination with one another insofar as technical considerations allow and also if this is not explicitly stated herein. Preferred embodiments of the inventive apparatus correspond to preferred embodiments of the inventive method, and vice versa, insofar as technical considerations allow and also if this is not explicitly stated herein.

To achieve the object, inventively a method is accordingly disclosed for determining a first quantity of a liquid in an oscillatingly suspended container having a rotatable component, wherein the rotatable component is driven by means of a electric motor for rotating at a specific speed by a specific current flowing through the electric motor. A supply line with a controllable supply valve for supplying the liquid into the container and a discharging facility for discharging the liquid from the container are provided, and wherein sensors for continuously acquiring operating data of the container and a control facility, connected to the sensors for transmitting the operating data, are provided for controlling the supply valve. At least two of the sensors are selected from a list of sensors comprising an oscillation sensor assigned to the container, a current sensor for measuring the current flowing through the motor, a speed sensor for measuring the speed of the motor, a pressure sensor for measuring a hydrostatic pressure prevailing in the container and a stopwatch for determining opening periods of the supply valve. The operating data acquired with the selected sensors is supplied to a correlation unit associated with the control facility, in which, on the basis of training data which was measured as operating data for the container in the case of a respectively specified first quantity, in particular a volume or a mass of the supplied liquid, learned correlations between the first quantity and the operating data are stored, and the correlation unit determines the first quantity from the operating data by the operating data being used as input variables for the correlation unit and the first quantity, in particular the volume or the mass of the liquid, being an output variable of the correlation unit.

To achieve the object, inventively an apparatus is likewise accordingly disclosed for carrying out the inventive method for determining a first quantity of a liquid, containing an oscillatingly suspended container, having a rotatable component, for receiving the liquid, wherein the rotatable component can be driven by means of a electric motor for rotating at a specific speed by a specific current flowing through the electric motor. A supply line with a controllable supply valve for supplying the liquid into the container, and a discharging facility for discharging the liquid from the container are provided, and wherein sensors for continuously acquiring operating data of the container and a control facility, connected to the sensors for transmitting the operating data are provided for controlling the supply valve. At least two of the sensors are selected from the list of sensors containing an oscillation sensor assigned to the container, a current sensor for measuring the current flowing through the motor, a speed sensor for measuring the speed of the motor, a pressure sensor for measuring a hydrostatic pressure prevailing in the container and a stopwatch for determining opening periods of the supply valve. It is provided that the operating data acquired with the selected sensors is supplied to a correlation unit associated with the control facility, in which, on the basis of training data which was measured as operating data for the container in the case of a respectively specified first quantity, learned correlations between the first quantity and the operating data are stored, and the correlation unit determines the first quantity from the operating data by the operating data being used as input variables for the correlation unit and the first quantity, in particular the volume or the mass of the liquid, being an output variable of the correlation unit.

There are no particular requirements with regard to selection and positioning of the various sensors, in particular of the oscillation sensor and the pressure sensor, so each sensor can be positioned by taking given spatial conditions into consideration and avoiding damage to the surroundings of the container and other components. The development of optimally large measurement signals and the presence of strong correlations between the measurement signals, the first quantity and possibly also further measures to be determined can also be sought.

To obtain the training data, precisely defined oscillations and signals of the sensors can be generated in the rotating component in the oscillatingly suspended container by way of the targeted introduction of calibration masses as well as precisely determined quantities of liquid, so by observing the corresponding oscillations of the container, the electrical current which the motor receives, the speed at which it rotates the rotating component and the hydrostatic pressure, optionally with associated variations, operating data is obtained which can subsequently serve to train the correlation unit. Measurements of the operating data without the introduction of calibration masses are also helpful, not least to be able to detect and take into account effects which result due to asymmetries in the rotating components themselves. Training data can of course also be generated by direct calculation of the operating data as a function of a specified imbalance, specified quantity of liquid and specified speed of the rotating components if the parameters describing the oscillatory system are known or could be deduced.

The measurement signals do not have to directly correspond or only be proportional to the respective operating data. Depending on availability, measurement signals can be acquired whose correspondence with the operating data is more complex. It is thus possible, for example, to determine the current through the motor as a measured variable which corresponds to the torque generated by the motor by way of the current. With a motor of the BLDC type, such a measured variable can be immediately available. In accordance with normal practice in laundry care machines, the pressure sensor can be a tube which is closed at its upper end, is directed upwards and filled with air and connected to a lower region of the container, which during normal operation is filled with liquid, with the actual pressure sensor being situated at the upper end in order to measure the pressure in the air compressed by liquid which has penetrated at the lower end of the tube. This pressure corresponds to the hydrostatic pressure in the lowest region of the container without necessarily having to be identical to it.

The oscillations, current, speed and pressure are measured, in particular, as respective time series of measured values, with in each case intervals between two immediately successive values being identical and corresponding to a fraction of a revolution period of the rotating component and an amplitude and a phase of a respective portion associated with rotational frequency of the rotating component corresponding to the revolution period, of the time series, being determined from each of the times series. These time series can be used directly in the framework of the invention as input values of the correlation unit, whereby possible preliminary work is avoided.

However, it is also conceivable and possible in the framework of the invention to subject the time series to preprocessing, for example in order to reduce noise effects and thereby increase the accuracy of the measurements. In particular, the time series can be subject to low-pass or bandpass filtering, possibly supported by the application of a fast Fourier transform.

The inventive method and the corresponding apparatus for its implementation therefore allow, with low expenditure on material and data processing, precise determination of a quantity of the liquid in the oscillatingly suspended container. In particular, it is not necessary to precisely and quantitatively describe the correlations between the first quantity and the operating data. The inventive method can be integrated in a procedure for application of the liquid in order to optimize the procedure, in particular with regard to duration, requirement for liquid as well as addition of additional agents to it and expenditure on energy. The accuracy of the output variable of the correlation unit can be improved, in particular, due to the use of at least two different types of sensor. It is also possible to use more than two different sensors for acquiring the operating data, whereby the accuracy of the output variable can advantageously be increased even further.

In a preferred development of the invention, a regression determined from the training data is implemented in the correlation unit, by way of which regression the first quantity is determined from the operating data. The training data forms a multi-dimensional matrix which represents correlations between the measured data and the data relating to the first quantity, possibly also further measures. With a regression, these correlations are approached by plane or curved hypersurfaces, with each such hypersurface defining a local functional relationship between the data, from which relationship it is possible to calculate or at least estimate values for the first quantity and potentially further desired data. More preferably, the regression is a recurrent regression which, in addition to the operating data, uses time-delayed output variables of the correlation unit, i.e. output variables which occurred at the correlation unit at earlier instants, as input variables. These output variables can be values of the first quantity, but other output variables can also be considered, for example intermediate results of the recursion, if they proceed in a plurality of calculation steps. More preferably, the correlation unit is a NARX network.

In another preferred embodiment of the invention, the correlation unit is a neural network trained with the training data. More preferably, the neural network is a recurrent neural network which, in addition to the operating data, uses time-delayed output variables of the recurrent neural network as input variables. Particularly advantageously, the neural network is an LSTM network. Similarly particularly preferably, the neural network is constructed with GRU units.

In a further preferred development of the invention, the first quantity is influenced by a filling, which can absorb the liquid, in the rotatable component, wherein the distribution of the filling is changed by the rotatable component rotating. This development opens up the application of the invention to a machine which serves to care for or treat a filling with liquid, with the filling being, in particular, items of laundry and the machine being a laundry care machine. More preferably, in addition to the first quantity, a second quantity is determined which indicates a portion of the liquid which is not absorbed by the filling. In a specific case of the laundry care machine and the items of laundry, such a portion of liquid which has not been absorbed is customarily referred to as “free liquor”. Even more preferably, the inventive method is applied to the filling situated in the rotating component for care by means of the liquid, wherein the filling has a textile material and wherein, in addition to the first quantity, the textile type of the filling is determined. Such a determination makes particular use of the fact that textiles of different types are distinguished by different absorption capacities for water or aqueous liquid and, in particular, if a dry mass of the textiles is known or ascertained from corresponding measurements at the container, on the basis of which the difference between supplied liquid as a whole and free liquor can be ascertained. Accordingly, a mass of the filling is even more preferably also determined from the first quantity, the second quantity and the textile type.

In another further preferred development of the invention, the liquid forms a foam as the rotating component rotates and the correlation unit also determines a third quantity which indicates a volume of the foam. This, as well as the quantity of free liquor and the mass of the filling, is an item of information which is of the utmost importance for controlling a care process for the filling, in particular items of laundry, and is helpful and useful for optimizing such a care process.

In another preferred development of the invention, the first quantity is determined almost continuously until the first quantity has reached a specified value, and a care process for the filling is performed by means of the liquid after the first quantity has reached the specified value. The application of the invention to control a care process is thereby opened up such that the care process can be configured and proceed on the basis of particularly precise addition of the liquid at the beginning of the care process. In particular, there is the possibility of adjusting the quantity of the liquid very precisely to requirements of the filling and of avoiding overdosages.

In yet another preferred development of the invention, the oscillation sensor measures the oscillations in three mutually orthogonal dimensions.

In another preferred development of the invention, a temperature of the liquid in the container is measured in addition to the operating data. It is thereby possible to coordinate the quantity of liquid with the temperature of the liquid and thus achieve even greater accuracy.

In another preferred development of the invention, the container is suspended in a housing by means of suspension struts and damper struts. As a result, reaction forces, which from the rotation of the rotatable components and the movement of the filling caused as a result, are absorbed and corresponding oscillations are damped.

In yet another preferred development of the invention, the apparatus is embodied as a laundry treatment machine, wherein the container is an outer tub, and wherein the rotatable component is a drum, arranged in the outer tub, for receiving the filling formed from items of laundry.

Basically, the invention can be applied to a laundry treatment machine of any type, especially since the expenditure necessary to apply the invention is very low. Apart from the conventional washing machine, the washer-dryer can thus also be considered. In this connection it is not a matter of how the axis of rotation of the drum is normally oriented in the space. The axis of rotation can be oriented substantially horizontally, as described in detail below, but it can also be vertical or be oriented at any angle to the vertical. The drum has, in particular, a cylindrical design with a casing extended parallel to the axis of rotation, a back wall, to which the drive shaft is connected, at its rear end, and a front sheet designed as a circular ring, through which the interior of the drum can be accessed in order to introduce and retrieve the items of laundry, at its front end.

In a further preferred development of the invention, a heating system for heating the liquid in the container and a power sensor for measuring a thermal power of the heating system are provided. As a result, apart from the temperature of the liquid, changes to it can also be precisely determined, and this further increases the accuracy of determination of the first quantity.

The advantages and effects disclosed for the inventive method apply equally to the corresponding inventive apparatus for carrying out the method, and vice versa. In particular, apparatus features can therefore also be worded as method features, and vice versa.

Other features which are considered as characteristic for the invention are set forth in the appended claims.

Although the invention is illustrated and described herein as embodied in a determining a quantity of a liquid in an oscillatingly suspended container, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration of an example of an inventively set up laundry treatment machine in a side view with an oscillatingly suspended container in which a rotating component is arranged;

FIG. 2 is an illustration of the laundry treatment machine in a front view; and

FIGS. 3 to 5 are graphs showing measurement results, determined with the inventive method.

### DETAILED DESCRIPTION OF THE INVENTION

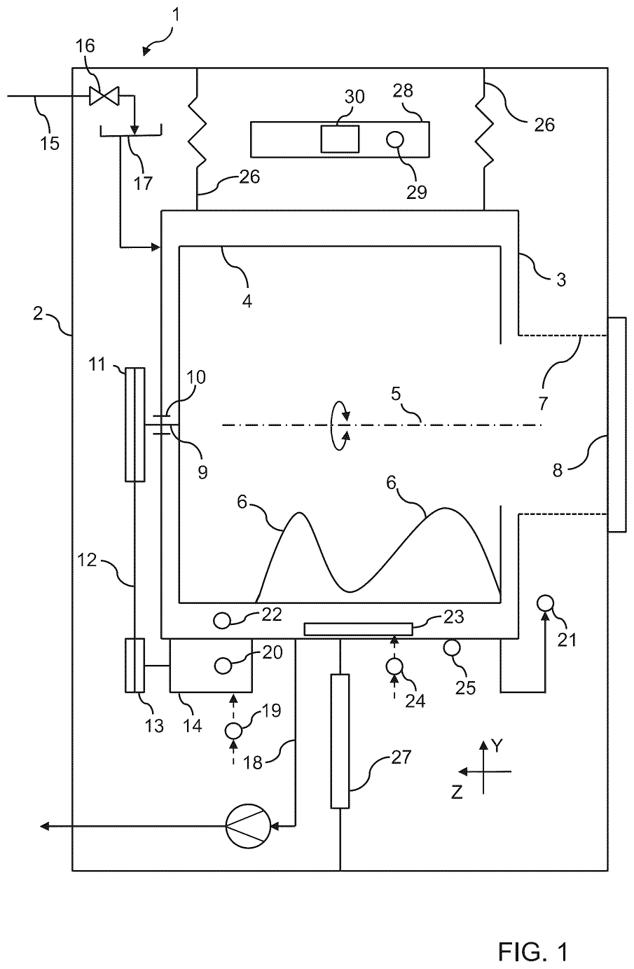

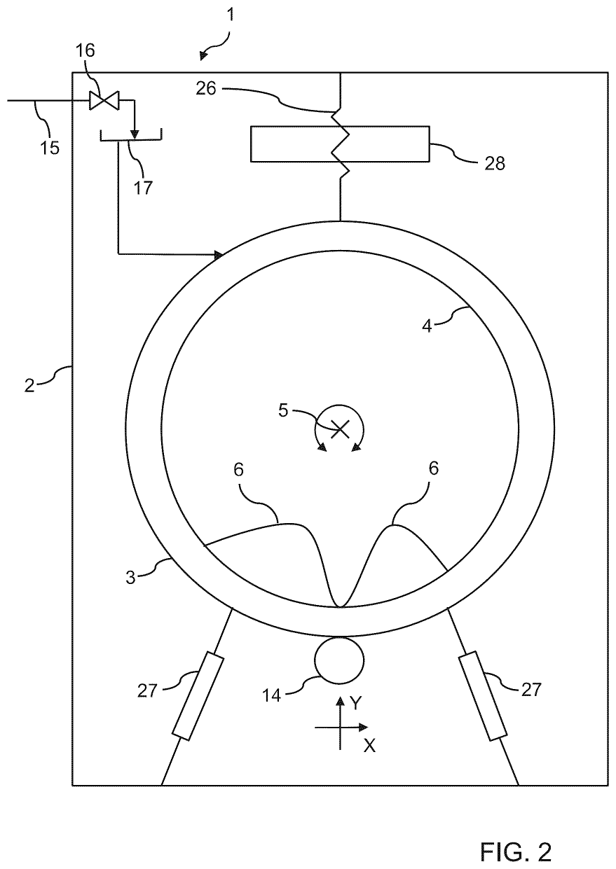

Referring now to the figures of the drawings in detail and first, particularly to FIGS. 1-2 thereof, there is shown in two mutually orthogonal sections-FIG. 1 in a view in a Y-Z plane, i.e. from the side, and FIG. 2 in a view in an X-Y plane, i.e. from the front-a schematized embodiment of a laundry treatment machine 1, embodied as an example of an apparatus for carrying out the inventive method. The laundry treatment machine 1 has a housing 2 and a container 3 arranged therein, namely an outer tub 3 for receiving a process liquid, in particular suds or soapy water for textiles.

The laundry treatment machine 1 is embodied as a washing machine 1. A component 5, which can rotate about an axis of rotation 5, namely a drum 4 is arranged in the outer tub 3. The axis of rotation 5 appears in FIG. 1 as a dash-dot line and in FIG. 2 as an X, in each case surrounded by a curved arrow as a symbol of the rotation. The drum 4 has a filling 6 composed of items of laundry 6 which are to be treated with a process liquid, with the filling 6 partially filling the drum 4 and it being possible for the filling to be mechanically treated by rotation of the drum 4. A substantially cylindrical casing of the outer tub 3 extends from a front end to a rear end of the outer tub 3 and forms a gap with the drum 4. Close to the front end the drum 4 is shut off by a substantially circular ring-shaped front sheet, close to the rear end by a substantially circular back wall. A seal 7, represented in broken lines in FIG. 1, made of pliable material, such as EPDM, connects the outer tub 3 in a fluid-tight manner to the housing 2, a door 8 outwardly shuts off the outer tub 3 during operation of the laundry treatment machine 1. For rotation, the drum 4 is driven by a drive shaft 9 which is led through the outer tub 3 on a shaft bearing so as to be sealed, a first belt pulley 11, a driving belt 12, a second belt pulley 13, and a motor 14 which is secured to the outer tub 3. A supply pipe 15 serves to supply fresh water from a public supply network or another supply. It includes an electrically controllable supply valve 16 for gauging the quantity of fresh water required in each case for a care process. This quantity of water passes firstly to a dispensing facility 17 where it is mixed with washing or rinsing-active agents, for example solid or liquid detergent preparation or fabric softener, and then passes into the outer tub 3. A controllable discharging facility 18, containing a pipe and a pump, is likewise provided in order to discharge the liquid from the outer tub on completion of a care process.

The sensor system used in the present example to carry out the inventive method contains a current sensor 19 for measuring the current flowing through the motor 14 during its operation, a speed sensor 20 for measuring a speed of the motor 14, a pressure sensor 21 for measuring a hydrostatic pressure prevailing in the outer tub 3 partially filled with liquid, a temperature sensor 22 for measuring the temperature of the liquid in the outer tub 3, a power sensor 24, assigned to a heating system 23 for the liquid in the outer tub 3, for measuring the thermal power which the heating system 23 generates to heat the liquid, and an oscillation sensor 25, in particular a 3D sensor 25, which measures oscillations of the outer tub 3 which are produced due to the rotation of the drum 4 and the associated movement of the items of laundry 6, which form the filling 6 of the drum 4 and ultimately can be attributed to asymmetries of the mass distribution within the drum 4 and imbalances emanating therefrom. A 3D sensor 25 can measure these oscillations in all three dimensions of the space. The current sensor 19 can be an electrical resistor, inserted in the pipe through which the current flows to the motor 14, across which resistor a voltage proportional to the current is measured, with it being possible for the resistor to be integrated in the control facility 28. The speed sensor 20 can be a coil situated in the motor 14, in which coil, when the motor 14 rotates the drum 4, a voltage is induced which is supplied to the control facility 28 for determining the speed. All of these sensors 19, 20, 21, 22, 24, 25 are basically known and do not require any further discussion at this juncture. Basically, any suitable known sensor can be used. In alternative exemplary embodiments, it is possible for only some of the sensors to be used to carry out the method, if inventively at least two of the sensors are selected.

The outer tub 3 is oscillatingly suspended in the housing 2 by means of suspension struts 26 and damper struts 27. Imbalances, which result, in particular, due to items of laundry 6 which are unevenly distributed in the drum 4 and, in particular, if the drum 4 is rotated particularly quickly in order to dehydrate the items of laundry 6 by centrifuging or spinning, can be particularly large, result in oscillations of the outer tub 3, which are absorbed by the suspension struts 26 and damper struts 27, with the energy of these oscillations in the damper struts 27 being converted into frictional heat and being released to the surroundings.

The control facility 28 serves to control the laundry treatment machine 1, in particular the motor 14 and other systems (not represented), and the acquisition and evaluation of the measured values mentioned above. Corresponding lines are shown only in exceptional cases as broken-line arrows. The control facility 28 includes a stopwatch 29 which is intended, in particular, to measure the opening times of the supply valve 16, and a correlation unit 30 with the aid of which the control facility 28, from the measurement data of the sensors 19, 20, 21, 22, 24, 25, determines a first quantity of the volume of liquid introduced into the outer tub 3 at the beginning of a care process. In particular, operating data of the oscillation sensor 25, the current sensor 19, the speed sensor 20 and the pressure sensor 21 is used for this, in addition operating data of the stop watch 29 for determining opening times of the supply valve 16, by this operating data being supplied to a correlation unit 30 associated with the control facility 28, in which unit, on the basis of training data which was measured as operating data for the outer tub 3 with a specified first quantity in each case, learned correlations between the first quantity and the operating data are stored, and the first quantity is determined by the correlation unit 30 from the operating data by the operating data being used as input variables for the correlation unit 30 and the first quantity being an output variable of the correlation unit 30. A plurality of embodiments exist in relation to the construction and function of the correlation unit 30.

In a first embodiment, a regression determined from the training data is implemented in the correlation unit 30, by way of which regression the first quantity is determined from the operating data. This regression is, in particular, a recurrent regression which, in addition to the operating data, uses time-delayed output variables of the correlation unit 30 as input variables. The correlation unit 30 is a NARX network in the present case.

In a second embodiment, the correlation unit 30 is a neural network trained with the training data. This neural network is, in particular, a recurrent neural network which, in addition to the operating data, uses time-delayed output variables of the recurrent neural network as input variables. The neural network is, in particular, an LSTM network and is constructed with GRU units.

In both embodiments, the time-delayed output variables which serve again as input variables, can be values of the first quantity or another quantity. They can also be output variables which are intermediate results of the processing of the input variables by the correlation unit 30.

In particular in the present application to a laundry care machine 1, the first quantity is influenced by the filling 6, made of a textile material, which can absorb the liquid, consisting of items of laundry 6 in the rotating component 4, with the distribution of the filling 6 changing by the rotatable component 4 rotating. In addition to the first quantity, a second quantity is determined which indicates a portion of the liquid which is not absorbed by the filling 6 and thus in everyday language forms a “free liquor”. A textile type of the filling 6 is also determined in the present case, in particular by evaluation of the development over time of the free liquor, with different textiles being assumed from the different absorption behaviors. A mass of the filling 6 is also additionally determined from the first quantity, the second quantity and the textile type. Furthermore, in this application, the liquid forms a foam as the rotating component rotates and the correlation unit 30 additionally determines a third quantity which indicates the volume of the foam. This volume can be determined directly or as the height of the foam above a calm level of the liquid in the outer tub 3.

The first quantity is virtually continuously determined as fresh water is let into the outer tub, until the first quantity has reached a specified value, and a care process for the filling 6 is carried out by means of the liquid after the first quantity has reached the specified value.

An oscillation sensor 23 is used which measures the oscillations in three mutually orthogonal dimensions. In this way, three kinds of operating data are available, namely the oscillations of the outer tub 3 in the three spatial dimensions, for evaluation in the framework of the inventive method. In addition, a temperature of the liquid in the container 3 is also measured by means of the temperature sensor 22, in addition to the operating data, in order to further increase the accuracy of determination of the first quantity.

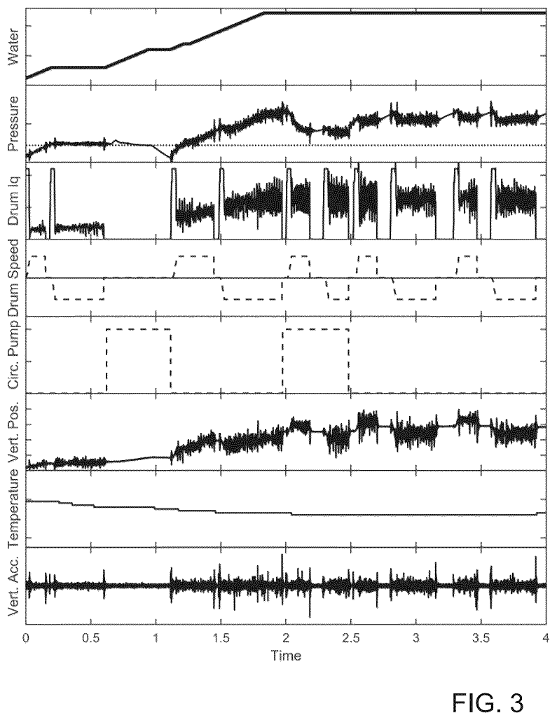

FIGS. 3 to 5 show different kinds of operating data of the laundry care machine 1 with a specified quantity of liquid and specified filling. The operating data appears in any units, with the scaling of these units being identical in each case across FIGS. 3 to 5. The ordinates of the operating data designated in the by “water” extends in each case from zero to the level of the respective abscissa up to 13 liters. In each case, time series of operating data are represented, i.e. operating data as functions of time, with the unit of time being a minute. It is also noted that the laundry care machine 1 used to acquire the operating data represented in FIGS. 3 to 5 has a circulation pump with which liquid can be pumped out of the lower region of the outer tub 3 and conveyed directly into the drum 4 to the filling 6.

FIGS. 3 to 5 show time series of the following operating data:
“Water” Volume of water in the outer tub 3, i.e. first quantity
“Pressure” Signal of the pressure sensor 21: the broken line shows the pressure when the free liquor touches the drum 4 from below (“immersion height”)
“Drum Iq” Current through the motor 14, measured with the current sensor 19;
“Drum Speed” Speed of the drum 4, positive and negative values corresponding to the reversing rotation of the drum 4;
“Circ pump” Switching-on or switching-off of the circulation pump;
Vert. Pos. Position signal of the 3D sensor 25, vertical component;
Temperature Signal of the temperature sensor 24 on the heating system 23; and
Vert. Acc. Acceleration signal of the 3D sensor 25, z-component.

FIG. 3 shows the correlations between operating data, such as current through the motor 14 and position and acceleration signal of the 3D sensor 25, which become apparent in significantly increased oscillations when the drum 4 rotates and the level of the liquid in the outer tub 3 is so high that the liquid arrives at the filling 6 in the drum 4. The “Pressure” signal identifies a drop, after the immersion height has initially been reached. This shows that the filling 6 in the drum 4 is absorbing the liquid, with the circulation pump conveying liquid from the lower region of the outer tub 3 directly to the filling 6 where the liquid is then absorbed and no longer passes back into the lower region of the outer tub.

FIG. 3 shows the correlations between the operating data and the first quantity when the laundry care machine 1 is loaded with a filling 6 of 2 kg of mixed textiles (cotton and synthetics), as may customarily be the case in a private household. Household-related items. As a special feature in the experiment of FIG. 3, the circulation pump is also switched on between the instants 0.6 minutes and 1.1 minutes, i.e. during an addition of fresh water. The effects of the supply of the fresh water and switching-on of the circulation pump cancel each other out and the signal “Pressure” thus remains, on average, constant in this period.

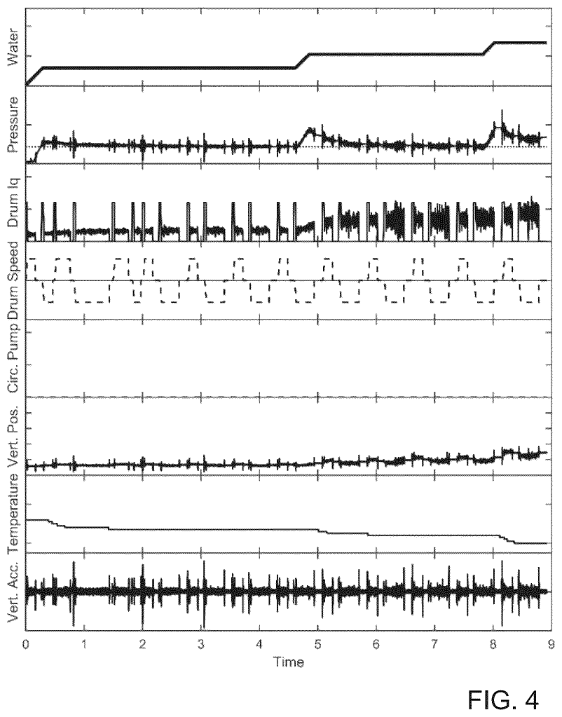

FIG. 4 shows the correlations between the operating data and the first quantity when the laundry care machine 1 is loaded with a filling 6 of 4 kg cotton-terry cloth (towels). The circulation pump is not used in this case. When the fresh water is let in via the supply pipe 15 and the supply valve 16, the pressure signal “Pressure” follows the increase in the liquid level in the outer tub 3 and remains relatively constant for a long time at the immersion height but shows significant fluctuations which are caused by the rotating of the drum 4. A brief increase in pressure substantially in the center of the graph follows a further addition of fresh water and the subsequent drop shows the absorption of the fresh water by the filling. Even after a further addition of fresh water at the right-hand side of the graph, the level of the fresh water in the outer tub, aside from fluctuations, does not rise significantly above the immersion height, and this means that the filling is still not completely saturated with liquid even at the end of the experiment. The current of the motor 14 increases on average, and this corresponds to the increased expenditure of energy for moving the filling 6 which has become heavier due to the absorbed liquid. The fluctuations in the current also increase for the same reason. On average, the position signal “Vert. Pos” of the 3D sensor 25 also increases, and this corresponds to a lowering of the outer tub 3 which has become heavier due to the added liquid. The fluctuations in this signal also increase as the addition of liquid increases. The drop in the temperature signal reflects the fact that the fresh water taken from the public network and which is not heated during the experiment is colder than the laundry care machine 1 and the filling 6.

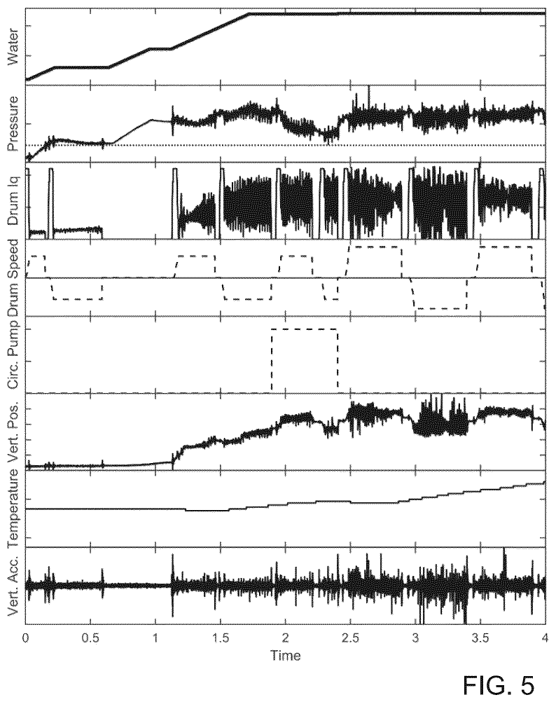

FIG. 5 shows the correlations between the operating data and the first quantity when the laundry care machine 1 is loaded with a filling 6 of 1 kg of synthetic textiles, i.e. textiles made of polyester fibers, polyamide fibers, or the like. The signals, represented in FIG. 5, of the various sensors 19, 20, 21, 22, 24 and 25 largely correspond to the signal sequences in FIG. 3, with the fluctuations in the signals being slightly greater. Up to an instant of 1.9 minutes, corresponding to switching-on of the circulation pump, which then runs until the instant 2.4 minutes, see corresponding signal sequence “Circ. Pump”, the behavior of all represented operating largely corresponds to the behavior as in FIG. 3. The current through the motor 14, see corresponding signal sequence “Drum Iq”, has only slight fluctuations at the beginning of the experiment up to the instant 0.6 minutes, and these increase greatly after wetting of the filling 6 from the instant 1.2 minutes. The same applies to the signal sequences “Vert. Pos.” and “Vert. Acc.” obtained by the 3D sensor 25, which can be attributed to a strong movement of the filling 6 in the rotating drum 4. The signal sequence “Pressure” shows that the filling 6 up to the instant 1 minute is practically completely saturated with liquid and fresh water which is subsequently added is no longer absorbed by the filling 6 and instead the free liquor increases. Switching-on of the circulation pump between 1.9 minutes and 2.4 minutes causes a drop in the signal “Pressure” in that the pipe system, which connects the circulation pump to the outer tub 3, is filled with liquid and the level of the liquid in the outer tub 3 drops. After the circulation pump has been switched off, the original level of the free liquor ensues. The reduced fluctuations in the signal sequences from the instant of 3.5 minutes indicate that the distribution of the filling 6 within the drum 4 has evened out.

As a result, FIGS. 3 to 5 substantiate the correlations between the quantity of liquid in the outer tub, the type and volume of the filling 6 and the signals of the various sensors 19, 20, 21, 22, 24 and 25. Thus, inventively, in particular the first quantity of liquid in the oscillatingly suspended container 3, namely the outer tub 3, which has a rotatable component 4, namely the drum 4, can thus be determined, with the rotatable component 4 being driven by means of the electric motor 14 for rotation at a specific speed by a specific current flowing through the electric motor 14, with a supply pipe 15 with a controllable supply valve 16 for supplying the liquid into the container 3 and a discharging facility 18 for discharging the liquid from the container 3 being provided, and with the sensors 19, 20, 21, 22, 24, 25 being provided for continuously acquiring operating data of the container 3 and a control facility 28, connected to the sensors 19, 20, 21, 22, 24, 25, for transmitting the operating data, being provided for controlling the supply valve 16, with the sensors 19, 20, 21, 22, 24, 25 also comprising an oscillation sensor 25, assigned to the container 3, a current sensor 19 for measuring the current flowing through the motor 14, a speed sensor 20 for measuring the speed of the motor 14 and a pressure sensor 21 for measuring a hydrostatic pressure prevailing in the container 3, as well as a stopwatch 29 for determining opening periods of the supply valve 16, and the operating data is supplied to a correlation unit 30 associated with the control facility 28, in which unit, on the basis of training data which was measured as operating data for the container 3 with a specified first quantity in each case, learned correlations between the first quantity and the operating data are stored, and the first quantity is determined by the correlation unit 30 from the operating data by the operating data being used as input variables for the correlation unit 30 and the first quantity being an output variable of the correlation unit 30.

The inventive method and the corresponding apparatus for its implementation thus allow, with little expenditure on material and data processing, precise determination of a quantity of the liquid in the oscillatingly suspended container. In particular, it is not necessary to describe the correlations between the first quantity and the operating data accurately and quantitatively. The inventive method can be integrated in a procedure for application of the liquid to optimize the procedure, in particular with regard to duration, requirement for liquid as well as addition of additional agents to it, and expenditure of energy.

The following is a summary list of reference numerals and the corresponding structure used in the above description of the invention:
1 laundry treatment machine
2 housing
3 oscillatingly suspended container, outer tub
4 rotatable component, drum
5 axis of rotation
6 filling, items of laundry
7 seal
8 door
9 drive shaft
10 shaft bearing
11 first belt pulley
12 drive belt
13 second belt pulley
14 motor
15 supply pipe
16 supply valve
17 dispensing facility
18 discharging facility
19 current sensor
20 speed sensor
21 pressure sensor
22 temperature sensor
23 heating system
24 power sensor
25 oscillation sensor, 3D sensor
26 suspension strut
27 damper strut
28 control facility
29 stop watch
30 correlation unit

1. A method for determining a first quantity of a liquid in an oscillatingly suspended container having a rotatable component, wherein the rotatable component is driven by means of a electric motor for rotating at a specific speed by a specific current flowing through the electric motor, wherein a supply line with a controllable supply valve for supplying the liquid into the oscillatingly suspended container and a discharging facility for discharging the liquid from the oscillatingly suspended container are provided, and wherein sensors for continuously acquiring operating data of the oscillatingly suspended container, and a controller, connected to the sensors for transmitting the operating data, are provided for controlling the controllable supply valve, which comprises the steps of:
selecting at least two of the sensors from a list of the sensors including an oscillation sensor assigned to the oscillatingly suspended container, which measures oscillations in three mutually orthogonal dimensions, a current sensor for measuring the specific current flowing through the electric motor, a speed sensor for measuring a speed of the electric motor, a pressure sensor for measuring a hydrostatic pressure prevailing in the oscillatingly suspended container and a stopwatch for determining opening periods of the controllable supply valve; and
supplying the operating data to a correlation unit associated with the controller, in which, on a basis of training data which was measured as the operating data for the oscillatingly suspended container in a case of a respectively specified first quantity, learned correlations between the first quantity and the operating data are stored, and the correlation unit determines the first quantity from the operating data by the operating data being used as input variables for the correlation unit and the first quantity being an output variable of the correlation unit.

2. The method according to claim 1, which further comprises implementing a regression determined from the training data in the correlation unit, by way of which said regression the first quantity is determined from the operating data.

3. The method according to claim 2, wherein the regression is a recurrent regression which, in addition to the operating data, uses time-delayed output variables of the correlation unit as the input variables.

4. The method according to claim 1, wherein the correlation unit is a neural network trained with the training data.

5. The method according to claim 4, wherein the neural network is a recurrent neural network which, in addition to the operating data, uses time-delayed output variables of the recurrent neural network as the input variables.

6. The method according to claim 1, wherein the first quantity is influenced by a filling, which can absorb the liquid, in the rotatable component, wherein a distribution of the filling is changed by the rotatable component rotating.

7. The method according to claim 6, wherein, in addition to the first quantity, a second quantity is determined which indicates a portion of the liquid which is not absorbed by the filling.

8. The method according to claim 7, wherein the method is applied to the filling situated in the rotating component for care by means of the liquid, wherein the filling has a textile material and wherein, in addition to the first quantity, a textile type of the filling is determined.

9. The method according to claim 8, which further comprises determining a mass of the filling from the first quantity, the second quantity and the textile type.

10. The method according to claim 8, wherein the liquid forms a foam as the rotating component rotates and the correlation unit also determines a third quantity which indicates a volume of the foam.

11. The method according to claim 6, which further comprises determining the first quantity continuously until the first quantity has reached a specified value, and wherein a care process for the filling is performed by means of the liquid after the first quantity has reached the specified value.

12. An apparatus for carrying out a method for determining a first quantity of a liquid, the apparatus comprising:
an electric motor;
an oscillatingly suspended container having a rotatable component for receiving the liquid, wherein said rotatable component being driven by means of said electric motor for rotating at a specific speed by a specific current flowing through said electric motor;
a supply line with a controllable supply valve for supplying the liquid into said oscillatingly suspended container;
a discharging facility for discharging the liquid from said oscillatingly suspended container;
sensors for continuously acquiring operating data of said oscillatingly suspended container;
a controller connected to said sensors for transmitting the operating data and for controlling said controllable supply valve;
at least two of said sensors are selected from a list of said sensors including an oscillation sensor assigned to said oscillatingly suspended container, a current sensor for measuring the specific current flowing through said electric motor, a speed sensor for measuring a speed of said electric motor, a pressure sensor for measuring a hydrostatic pressure prevailing in said oscillatingly suspended container and a stopwatch for determining opening periods of said controllable supply valve; and
a correlation unit, the operating data being supplied to said correlation unit associated with said controller, in which, on a basis of training data which was measured as the operating data for said oscillatingly suspended container in a case of a respectively specified first quantity, learned correlations between the first quantity and the operating data are stored, and said correlation unit determines the first quantity from the operating data by the operating data being used as input variables for said correlation unit and the first quantity being an output variable of said correlation unit.

13. The apparatus according to claim 12, wherein a regression determined from the training data is implemented in said correlation unit, by the regression the first quantity is determined from the operating data.

14. The apparatus according to claim 12, wherein said correlation unit is a neural network trained with the training data.

15. The apparatus according to claim 12, wherein:
the apparatus is a laundry treatment machine;
said oscillatingly suspended container is an outer tub; and
said rotatable component is a drum, disposed in said outer tub, for receiving a filling formed from items of laundry.

16. The apparatus according to claim 13, wherein said correlation unit is a nonlinear autoregressive with exogenous inputs (NARX) network.

17. The apparatus according to claim 14, wherein said correlation unit is a long short-term memory (LSTM) network or constructed with gated recurrent units (GRU).
